(19) United States
(12) Patent Application Publication
(10) Pub. No.: US 2024/0057090 A1
(43) Pub. Date: Feb. 15, 2024

(54) ALLOCATING UPLINK CHANNEL RESOURCES FOR NEGATIVE ACKNOWLEDGEMENT ONLY BASED MULTICAST FEEDBACK

(71) Applicant: QUALCOMM Incorporated, San Diego, CA (US)

(72) Inventors: Le LIU, San Jose, CA (US); Alberto RICO ALVARINO, San Diego, CA (US); Ayan SENGUPTA, San Diego, CA (US); Peter GAAL, San Diego, CA (US); Kazuki TAKEDA, Minato-ku (JP)

(21) Appl. No.: 18/336,608

(22) Filed: Jun. 16, 2023

Related U.S. Application Data
(60) Provisional application No. 63/371,332, filed on Aug. 12, 2022.

(51) Int. Cl. H04W 72/21; H04L 5/00

(52) U.S. Cl. CPC H04W 72/21; H04L 5/0055

(57) ABSTRACT

Various aspects of the present disclosure generally relate to wireless communication. In some aspects, a user equipment (UE) may receive, from a network node, an indication of one of: a quantity of physical uplink control channel (PUCCH) resources in a PUCCH slot for negative acknowledgement (NACK)-only-based multicast feedback, or a quantity of transport blocks (TBs) with the NACK-only-based multicast feedback to be multiplexed in the PUCCH slot. The UE may determine, based at least in part on the indication, the quantity of PUCCH resources in the PUCCH slot for the NACK-only-based multicast feedback. The UE may determine a physical downlink shared channel (PDSCH) processing timeline. The UE may transmit, to the network node, the NACK-only-based multicast feedback using the quantity of PUCCH resources and based at least in part on the PDSCH processing timeline. Numerous other aspects are described.

### CROSS-REFERENCE TO RELATED APPLICATION

This patent application claims priority to U.S. Provisional Patent Application No. 63/371,332, filed on Aug. 12, 2022, entitled “ALLOCATING UPLINK CHANNEL RESOURCES FOR NEGATIVE ACKNOWLEDGEMENT ONLY BASED MULTICAST FEEDBACK,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for allocating uplink channel resources for negative acknowledgement (NACK)-only-based multicast feedback.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes one or more memories; and one or more processors coupled to the one or more memories, the one or more processors individually or collectively configured to: receive, from a network node, an indication of one of: a quantity of physical uplink control channel (PUCCH) resources in a PUCCH slot for negative acknowledgement (NACK)-only-based multicast feedback, or a quantity of transport blocks (TBs) with the NACK-only-based multicast feedback to be multiplexed in the PUCCH slot; determine, based at least in part on the indication, the quantity of PUCCH resources in the PUCCH slot for the NACK-only-based multicast feedback; determine a physical downlink shared channel (PDSCH) processing timeline based at least in part on the quantity of PUCCH resources for the NACK-only-based multicast feedback; and transmit, to the network node, the NACK-only-based multicast feedback using the quantity of PUCCH resources and based at least in part on the PDSCH processing timeline.

In some implementations, an apparatus for wireless communication at a network node includes one or more memories; and one or more processors coupled to the one or more memories, the one or more processors individually or collectively configured to: transmit, to a UE, an indication of one of: a quantity of PUCCH resources in a PUCCH slot for NACK-only-based multicast feedback, or a quantity of TBs with the NACK-only-based multicast feedback to be multiplexed in the PUCCH slot; and receive, from the UE, the NACK-only-based multicast feedback based at least in part on the quantity of PUCCH resources and a PDSCH processing timeline, wherein the quantity of PUCCH resources is based at least in part on the indication, and wherein the PDSCH processing timeline is based at least in part on the quantity of PUCCH resources for the NACK-only-based multicast feedback.

In some implementations, a method of wireless communication performed by a UE includes receiving, from a network node, an indication of one of: a quantity of PUCCH resources in a PUCCH slot for NACK-only-based multicast feedback, or a quantity of TBs with the NACK-only-based multicast feedback to be multiplexed in the PUCCH slot; determining, based at least in part on the indication, the quantity of PUCCH resources in the PUCCH slot for the NACK-only-based multicast feedback; determining a PDSCH processing timeline based at least in part on the quantity of PUCCH resources for the NACK-only-based multicast feedback; and transmitting, to the network node, the NACK-only-based multicast feedback using the quantity of PUCCH resources and based at least in part on the PDSCH processing timeline.

In some implementations, a method of wireless communication performed by a network node includes transmitting, to a UE, an indication of one of: a quantity of PUCCH resources in a PUCCH slot for NACK-only-based multicast feedback, or a quantity of TBs with the NACK-only-based multicast feedback to be multiplexed in the PUCCH slot; and receiving, from the UE, the NACK-only-based multicast feedback based at least in part on the quantity of PUCCH resources and a PDSCH processing timeline, wherein the quantity of PUCCH resources is based at least in part on the indication, and wherein the PDSCH processing timeline is based at least in part on the quantity of PUCCH resources for the NACK-only-based multicast feedback.

In some implementations, a non-transitory computer-readable medium storing a set of instructions for wireless communication includes one or more instructions that, when executed by one or more processors of a UE, cause the UE to: receive, from a network node, an indication of one of: a quantity of PUCCH resources in a PUCCH slot for NACK-only-based multicast feedback, or a quantity of TBs with the NACK-only-based multicast feedback to be multiplexed in the PUCCH slot; determine, based at least in part on the indication, the quantity of PUCCH resources in the PUCCH slot for the NACK-only-based multicast feedback; determine a PDSCH processing timeline based at least in part on the quantity of PUCCH resources for the NACK-only-based multicast feedback; and transmit, to the network node, the NACK-only-based multicast feedback using the quantity of PUCCH resources and based at least in part on the PDSCH processing timeline.

In some implementations, a non-transitory computer-readable medium storing a set of instructions for wireless communication includes one or more instructions that, when executed by one or more processors of a network node, cause the network node to: transmit, to a UE, an indication of one of: a quantity of PUCCH resources in a PUCCH slot for NACK-only-based multicast feedback, or a quantity of TBs with the NACK-only-based multicast feedback to be multiplexed in the PUCCH slot; and from the UE, the NACK-only-based multicast feedback based at least in part on the quantity of PUCCH resources and a PDSCH processing timeline, wherein the quantity of PUCCH resources is based at least in part on the indication, and wherein the PDSCH processing timeline is based at least in part on the quantity of PUCCH resources for the NACK-only-based multicast feedback.

In some implementations, an apparatus for wireless communication includes means for receiving, from a network node, an indication of one of: a quantity of PUCCH resources in a PUCCH slot for NACK-only-based multicast feedback, or a quantity of TBs with the NACK-only-based multicast feedback to be multiplexed in the PUCCH slot; means for determining, based at least in part on the indication, the quantity of PUCCH resources in the PUCCH slot for the NACK-only-based multicast feedback; means for determining a PDSCH processing timeline based at least in part on the quantity of PUCCH resources for the NACK-only-based multicast feedback; and means for transmitting, to the network node, the NACK-only-based multicast feedback using the quantity of PUCCH resources and based at least in part on the PDSCH processing timeline.

In some implementations, an apparatus for wireless communication includes means for transmitting, to a UE, an indication of one of: a quantity of PUCCH resources in a PUCCH slot for NACK-only-based multicast feedback, or a quantity of TBs with the NACK-only-based multicast feedback to be multiplexed in the PUCCH slot; and means for receiving, from the UE, the NACK-only-based multicast feedback based at least in part on the quantity of PUCCH resources and a PDSCH processing timeline, wherein the quantity of PUCCH resources is based at least in part on the indication, and wherein the PDSCH processing timeline is based at least in part on the quantity of PUCCH resources for the NACK-only-based multicast feedback.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of transmitting feedback, in accordance with the present disclosure.

FIGS. 5-6 are diagrams illustrating examples associated with allocating uplink channel resources for negative acknowledgement (NACK)-only-based multicast feedback, in accordance with the present disclosure.

FIGS. 7-8 are diagrams illustrating example processes associated with allocating uplink channel resources for NACK-only-based multicast feedback, in accordance with the present disclosure.

FIGS. 9-10 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

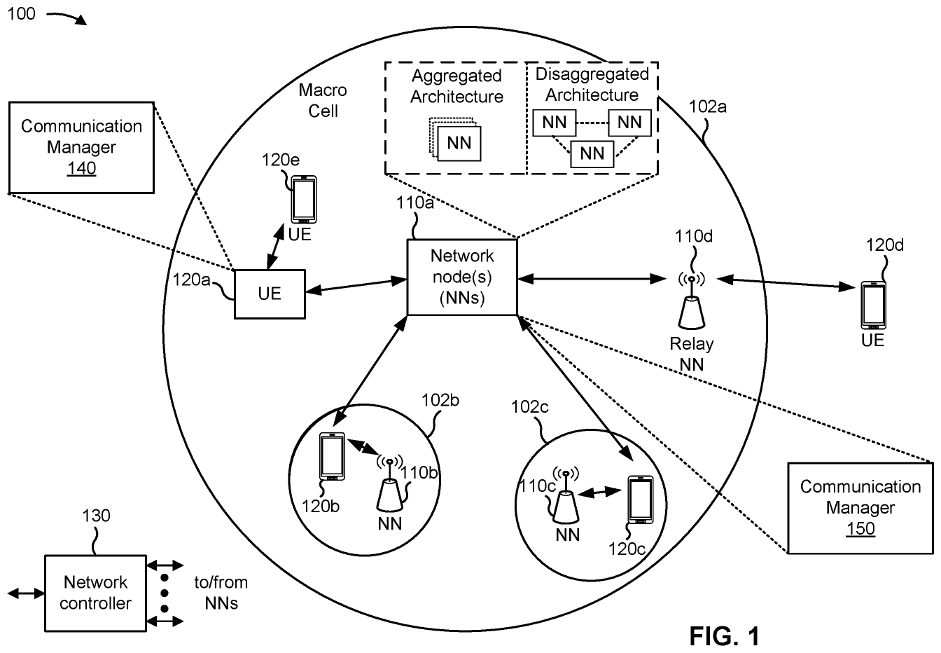

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, from a network node, an indication of one of: a quantity of physical uplink control channel (PUCCH) resources in a PUCCH slot for negative acknowledgement (NACK)-only-based multicast feedback, or a quantity of transport blocks (TBs) with the NACK-only-based multicast feedback to be multiplexed in the PUCCH slot; determine, based at least in part on the indication, the quantity of PUCCH resources in the PUCCH slot for the NACK-only-based multicast feedback; determine a physical downlink shared channel (PDSCH) processing timeline based at least in part on the quantity of PUCCH resources for the NACK-only-based multicast feedback; and transmit, to the network node, the NACK-only-based multicast feedback using the quantity of PUCCH resources and based at least in part on the PDSCH processing timeline. Additionally, or alternatively, the communication manager 140 may perform one or more other operations described herein.

In some aspects, a network node (e.g., network node) may include a communication manager 150. As described in more detail elsewhere herein, the communication manager 150 may transmit, to a UE, an indication of one of: a quantity of PUCCH resources in a PUCCH slot for NACK-only-based multicast feedback, or a quantity of TBs with the NACK-only-based multicast feedback to be multiplexed in the PUCCH slot; and receive, from the UE, the NACK-only-based multicast feedback based at least in part on the quantity of PUCCH resources and a PDSCH processing timeline, wherein the quantity of PUCCH resources is based at least in part on the indication, and wherein the PDSCH processing timeline is based at least in part on the quantity of PUCCH resources for the NACK-only-based multicast feedback. Additionally, or alternatively, the communication manager 150 may perform one or more other operations described herein.

As indicated above, FIG. 1 is provided as an example. Other examples may differ from what is described with regard to FIG. 1.

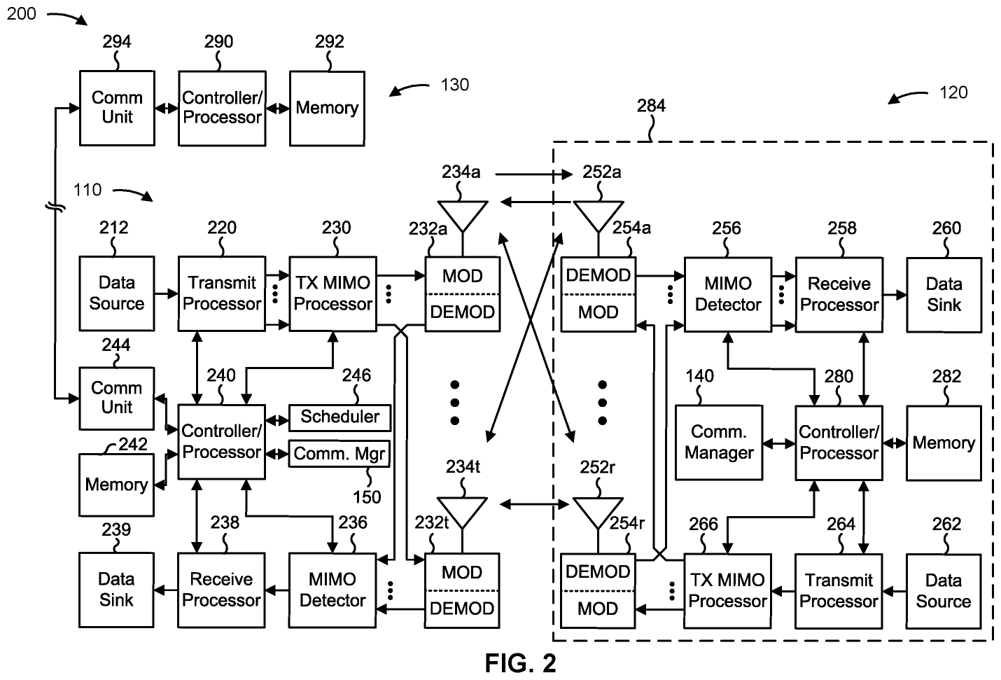

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

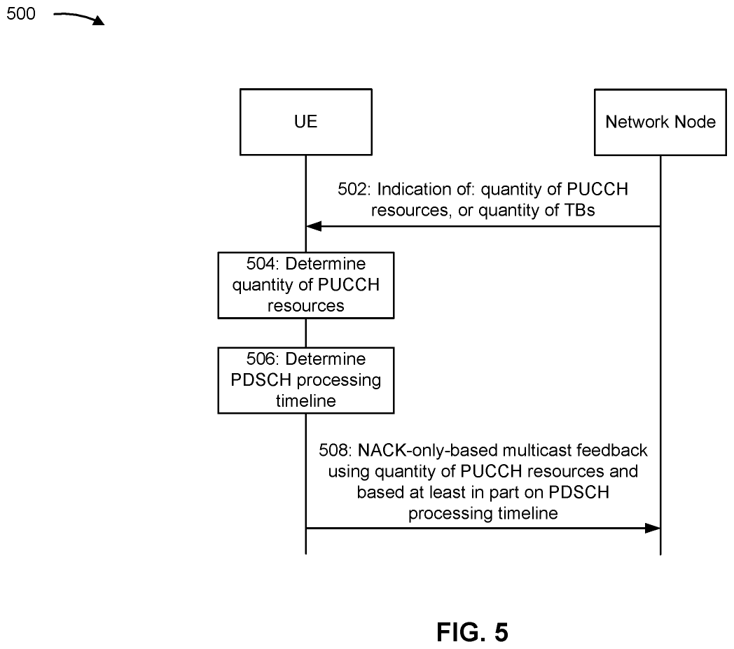

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-10).

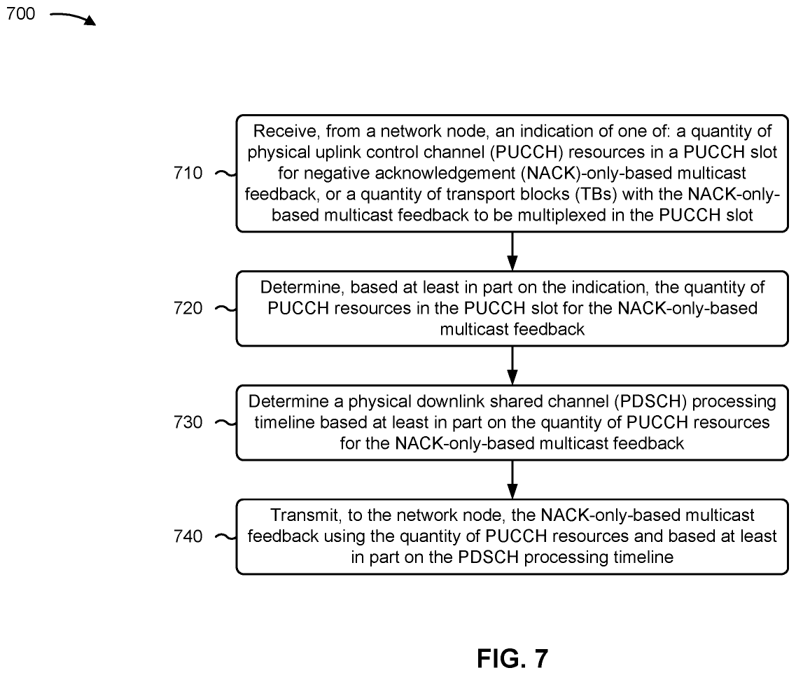

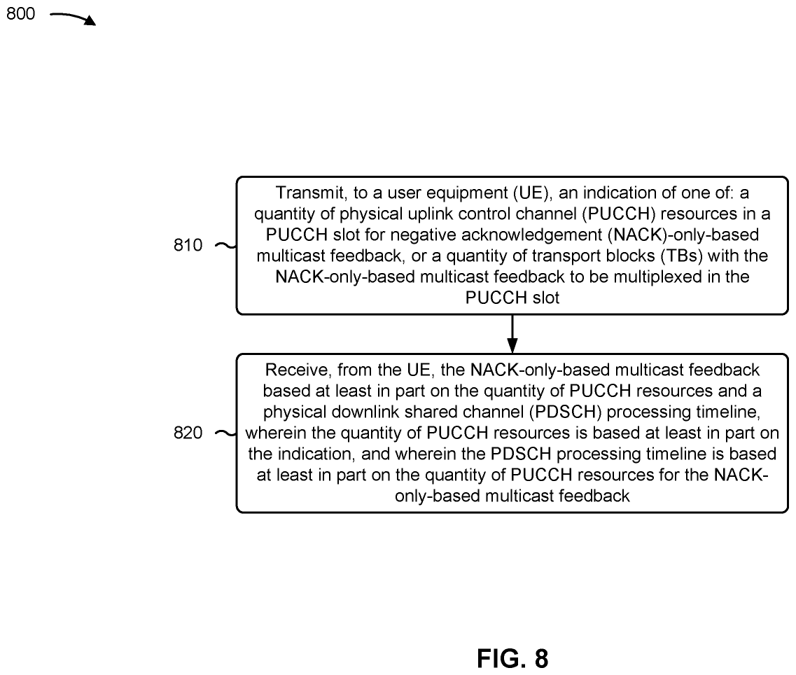

The controller/processor 240 of the network node 110, the controller/processor 280 of the UE 120, and/or any other component(s) of FIG. 2 may perform one or more techniques associated with allocating uplink channel resources for NACK-only-based multicast feedback, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, from a network node, an indication of one of: a quantity of PUCCH resources in a PUCCH slot for NACK-only-based multicast feedback, or a quantity of TBs with the NACK-only-based multicast feedback to be multiplexed in the PUCCH slot; means for determining, based at least in part on the indication, the quantity of PUCCH resources in the PUCCH slot for the NACK-only-based multicast feedback; means for determining a PDSCH processing timeline based at least in part on the quantity of PUCCH resources for the NACK-only-based multicast feedback; and/or means for transmitting, to the network node, the NACK-only-based multicast feedback using the quantity of PUCCH resources and based at least in part on the PDSCH processing timeline. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., network node 110) includes means for transmitting, to a UE, an indication of one of: a quantity of PUCCH resources in a PUCCH slot for NACK-only-based multicast feedback, or a quantity of TBs with the NACK-only-based multicast feedback to be multiplexed in the PUCCH slot; and/or means for receiving, from the UE, the NACK-only-based multicast feedback based at least in part on the quantity of PUCCH resources and a PDSCH processing timeline, wherein the quantity of PUCCH resources is based at least in part on the indication, and wherein the PDSCH processing timeline is based at least in part on the quantity of PUCCH resources for the NACK-only-based multicast feedback. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

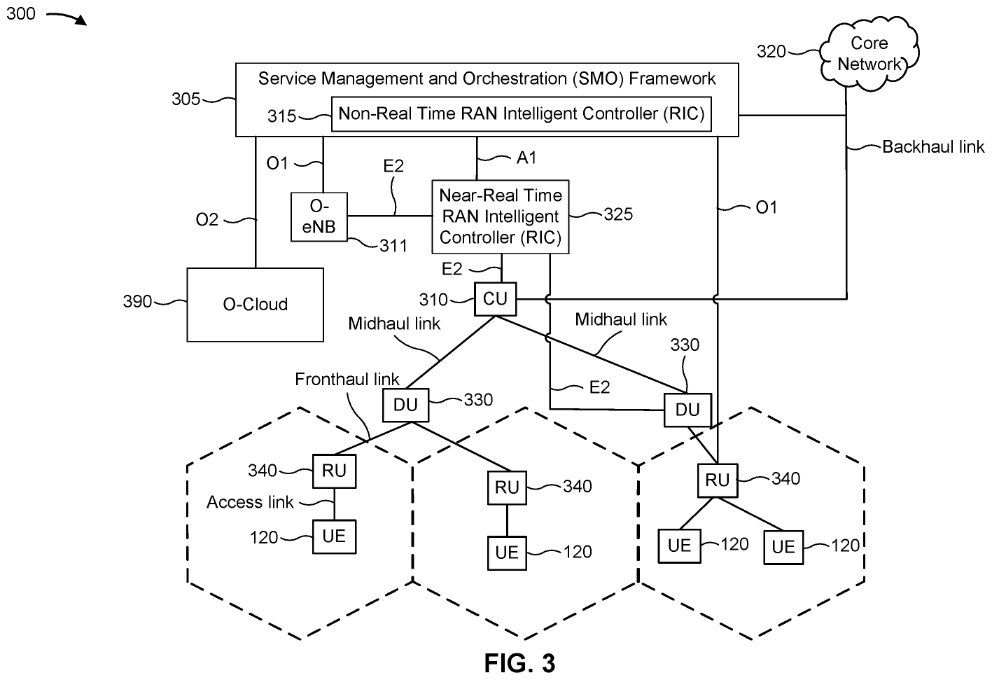

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface).

For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

Two feedback modes for multicast may be configured per group radio network temporary identifier (G-RNTI) or per group configured scheduling radio network temporary identifier (G-CS-RNTI) via unicast RRC signaling. A first feedback mode for multicast may be an acknowledgement (ACK) or negative acknowledgement (NACK) based hybrid automatic repeat request (HARQ) ACK feedback (e.g., an ACK/NACK-based HARQ-ACK feedback). A second feedback mode for multicast may be a NACK-only-based HARQ-ACK feedback.

A physical uplink control channel (PUCCH) format may be used for NACK-only-based HARQ-ACK feedback. A PUCCH format 0 and format 1 with cyclic shift 0 may be used for NACK-only-based HARQ-ACK feedback for multicast. A PUCCH resource configuration for HARQ-ACK feedback from a per UE perspective may be separate from that of unicast. A PUCCH resource for NACK-only-based HARQ-ACK feedback may be shared by UEs transmitting NACK-only-based HARQ-ACK feedback.

When more than one NACK-only-based multicast feedback is available for transmission in the same PUCCH slot, and when a more than one NACK only mode (moreThanOneNackOnly-Mode) is not configured, HARQ-ACK bits may be multiplexed by transforming NACK-only-based multicast feedback into ACK/NACK HARQ bits. The moreThanOneNackOnly-Mode may be a configurable RRC parameter and may be based at least in part on a UE capability. Otherwise (e.g., when moreThanOneNackOnly-Mode is configured), up to 15 orthogonal PUCCH resources may be used to select from, according to combinations of up to four TBs with NACK-only feedback. PUCCH resources for transmitting multiplexed HARQ-ACK bits may be from a PUCCH configuration or PUCCH configuration list (PUCCH-Config/PUCCH-ConfigurationList) configured for multicast.

A UE processing time (T_{Proc1}) may be a minimum required gap between an end of a physical downlink shared channel (PDSCH) reception and an earliest possible start of a PUCCH carrying a corresponding HARQ-ACK. The UE may be required to finish the PDSCH reception and a PUCCH preparation during a T_{Proc1} time.

A PDSCH and/or a PUCCH processing timeline for a NACK-only-based multicast feedback may be extended, as compared to the UE processing time (T_{Proc1}), which may be for ACK/NACK based feedback. For NACK-only-based multicast feedback for more than one TB, one issue may be that a PUCCH resource for the NACK-only-based multicast feedback may only be determined after obtaining a decoding result of all of the related PDSCHs for the UE. In order to resolve this issue, the PDSCH processing timeline for NACK-only-based multicast feedback may be extended according to T_{Proc1_NACK}=T_{Proc1}+T_{offset}, where T_{Proc1} is a processing time and is based at least in part on a UE processing capability, and T_{offset} is a processing time offset value. A PUCCH resource from a resource set configured for NACK-only-based multicast feedback may be selected to be used for a reference PUCCH for defining T_{Proc1}.

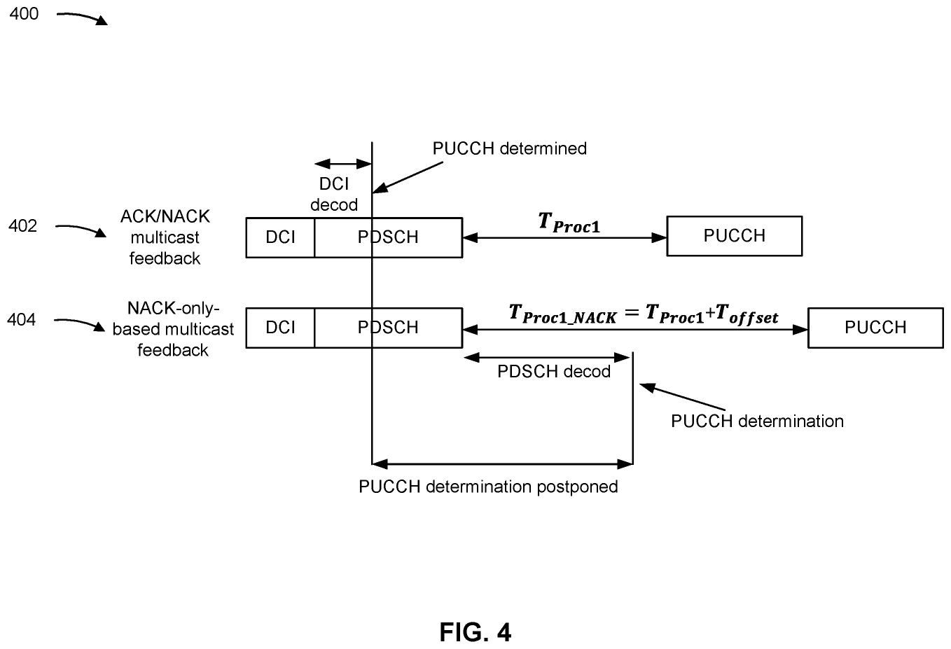

FIG. 4 is a diagram illustrating examples 400 of transmitting feedback, in accordance with the present disclosure.

As shown by reference number 402, a network node may transmit downlink control information (DCI) to a UE. The network node may transmit a PDSCH to the UE, which may be scheduled by the DCI. The UE may transmit, to the network node, ACK/NACK multicast feedback via a PUCCH. The UE may determine the PUCCH during a PDSCH reception. An amount of time between an end of the PDSCH reception and a start of a PUCCH transmission may correspond to a UE processing time (T_{Proc1}).

As shown by reference number 404, a network node may transmit DCI to a UE. The network node may transmit a PDSCH to the UE, which may be scheduled by the DCI. The UE may transmit, to the network node, a NACK-only-based multicast feedback via a PUCCH. The UE may determine the PUCCH after a PDSCH reception.

An amount of time between an end of the PDSCH reception and a start of a PUCCH transmission may correspond to an extended UE processing time (T_{Proc1_NACK}=T_{Proc1}+T_{offset}). A value of T_{offset} may be equal to a time gap between a physical downlink control channel (PDCCH) (e.g., which carries the DCI) ending symbol and a PDSCH ending symbol plus N1, where N1 is based at least in part on a UE processing capability. The value of T_{offset} may be based at least in part on a UE capability, which may be reported to the network node.

As indicated above, FIG. 4 is provided as an example. Other examples may differ from what is described with regard to FIG. 4.

For NACK-only-based multicast feedback, when a nominal NACK-only PUCCH overlaps with another PUCCH/PUSCH transmission, the NACK-only-based multicast feedback may be transformed into ACK/NACK feedback and multiplexed with the other PUCCH/PUSCH transmission. The nominal NACK-only PUCCH may include all of the symbols from PUCCHs of a NACK-only PUCCH resource set. The nominal NACK-only PUCCH may start from an earliest starting symbol of PUCCHs in the NACK-only PUCCH resource set, and the nominal NACK-only PUCCH may end at a latest ending symbol of PUCCHs in the NACK-only PUCCH resource set. The nominal NACK-only PUCCH may include all of the symbols of a PUCCH slot. A plurality of PUCCHs (e.g., all PUCCHs) may have the same starting symbol and the same time duration. The nominal NACK-only PUCCH may be based at least in part on a PUCCH resource identifier (PRI). The nominal NACK-only PUCCH may be based at least in part on a quantity of TBs that are to be transmitted in the PUCCH slot.

Certain factors may be considered when determining the nominal NACK-only PUCCH based at least in part on a down-selection. For example, up to 12 initial cyclic shifts may be configured for PUCCH format 0. Up to 12 initial cyclic shifts and up to 7 time domain orthogonal cover codes (OCCs) may be configured for PUCCH format 1. One PUCCH may be insufficient to support up to 15 PUCCH sequences. Up to 32 PUCCH resources in a resource set may be configured for NACK-only-based multicast feedback. A PUCCH configuration for unicast may be used when a PUCCH is not configured for NACK-only-based multicast feedback. In a given slot, different PUCCHs may be associated with varying quantities of resources.

Various parameters may be defined for PUCCH format 0 and PUCCH format 1. A starting symbol may be 0-13 for PUCCH format 0. A starting symbol may be 0-10 for PUCCH format 1. A quantity of symbols in a slot may be one or two for PUCCH format 0. A quantity of symbols in a slot may be 4-14 for PUCCH format 1. An Idx (e.g., an identifier) of a starting physical resource block (PRB) may be 0-274 for PUCCH format 0. An Idx of a starting PRB may be 0-274 for PUCCH format 1. A quantity of PRBs may be one for PUCCH format 0 (not configurable). A quantity of PRBs may be one for PUCCH format 1 (not configurable). A frequency hopping flag may be present for PUCCH format 0 (only for 2-symbol). A frequency hopping flag may be present for PUCCH format 1. A frequency resource of a second hop when frequency hopping is present may be 0-274 for PUCCH format 0. A frequency resource of a second hop when frequency hopping is present may be 0-274 for PUCCH format 1. An Idx of an initial cyclic shift may be 0-11 for PUCCH format 0. An Idx of an initial cyclic shift may be 0-11 for PUCCH format 1. An Idx of a time domain OCC may be not applicable for PUCCH format 0. An Idx of a time domain OCC may be 0-6 for PUCCH format 1. A quantity of slots (semi-statically configured) may be not applicable for PUCCH format 0. A quantity of slots (semi-statically configured) may be {1,2,4,8} for PUCCH format 1.

When more than one PUCCH is needed to multiplex X TBs for NACK-only-based multicast feedback, a UE may need to select a resource among different PUCCHs based at least in part on PDSCH detection results. However, the UE may not be configured to appropriately select the resource among the different PUCCHs. Further, PUCCH resources may not be allocated in a time and/or frequency domain for NACK-only-based multicast feedback when a moreThanOneNackOnly-Mode is configured.

For example, when a maximum of three TBs with feedback bits need to be multiplexed, a sufficient quantity of orthogonal PUCCH sequences may be available in one PUCCH resource. For three TBs, 7 orthogonal sequences in one resource block may be used for PUCCH format 0 or PUCCH format 1. When there are four TBs with feedback bits to be multiplexed, at least two resource blocks for PUCCH format 0 or PUCCH format 1 may be needed. However, a mechanism for allocating the two resource blocks and for setting a duration associated with the two resource blocks may need to be defined for the context of NACK-only-based multicast feedback when the moreThanOneNackOnly-Mode is configured.

In various aspects of techniques and apparatuses described herein, a UE may receive an indication from a network node. The indication may indicate a quantity of PUCCH resources in a PUCCH slot for NACK-only-based multicast feedback, or the indication may indicate a quantity (e.g., X) of TBs with the NACK-only-based multicast feedback to be multiplexed in the PUCCH slot. The UE may be configured with a moreThanOneNackOnly-Mode, which may enable the UE to report more than one NACK as part of a multicast feedback. The UE may determine, based at least in part on the indication, the quantity of PUCCH resources in the PUCCH slot for the NACK-only-based multicast feedback. In other words, the quantity of PUCCH resources may depend on the quantity of TBs to be multiplexed in the PUCCH slot. The UE may determine a PDSCH processing timeline based at least in part on the quantity of PUCCH resources for the NACK-only-based multicast feedback. The UE may transmit, to the network node, the NACK-only-based multicast feedback using the quantity of PUCCH resources and based at least in part on the PDSCH processing timeline. In some aspects, by the network node indicating the quantity of PUCCH resources or the quantity of TBs, the UE may be able to determine the quantity of PUCCH resources needed for the NACK-only-based multicast feedback and the PDSCH processing timeline (e.g., a legacy PDSCH processing timeline or an extended PDSCH processing timeline). As a result, the UE may be able to allocate PUCCH resources for the NACK-only-based multicast feedback when the moreThanOneNackOnly-Mode is configured for the UE. Otherwise, the UE may attempt to transmit the NACK-only-based multicast feedback in inappropriate PUCCH resources, which may waste resources and/or reduce a performance of the UE.

FIG. 5 is a diagram illustrating an example 500 associated with allocating uplink channel resources for NACK-only-based multicast feedback, in accordance with the present disclosure. As shown in FIG. 5, example 500 includes communication between a UE (e.g., UE 120) and a network node (e.g., network node 110). In some aspects, the UE and the network node may be included in a wireless network, such as wireless network 100.

As shown by reference number 502, the UE may receive, from the network node, an indication of a quantity of PUCCH resources in a PUCCH slot for NACK-only-based multicast feedback, or a quantity of TBs (e.g., X TBs) with the NACK-only-based multicast feedback to be multiplexed in the PUCCH slot. The UE may receive, from the network node, the indication of the quantity of PUCCH resources or the quantity of TBs via a unicast RRC signaling. The UE may receive, from the network node, the indication of the quantity of PUCCH resources or the quantity of TBs via DCI based at least in part on repurposing a PRI field in a DCI format that is associated with a G-RNTI/G-CS-RNTI configured with the NACK-only-based multicast feedback. In some aspects, a moreThanOneNackOnly-Mode may be configured for the UE, which may enable the UE to report more than one NACK as part of a multicast feedback.

As shown by reference number 504, the UE may determine, based at least in part on the indication, the quantity of PUCCH resources in the PUCCH slot for the NACK-only-based multicast feedback. The quantity of PUCCH resources may depend on the quantity of TBs to be multiplexed in the PUCCH slot. For example, the quantity of PUCCH resources may be one based at least in part on the quantity of TBs being less than or equal to a predefined value (e.g., three). As another example, the quantity of PUCCH resources may be more than one based at least in part on the quantity of TBs being larger than a predefined value (e.g., four).

As shown by reference number 506, the UE may determine a PDSCH processing timeline based at least in part on the quantity of PUCCH resources for the NACK-only-based multicast feedback. The PDSCH processing timeline may be a legacy PDSCH processing timeline used for ACK/NACK based feedback based at least in part on the quantity of PUCCH resources being one. The PDSCH processing timeline may be an extended PDSCH processing timeline based at least in part on the quantity of PUCCH resources being greater than one. The extended PDSCH processing timeline may be based at least in part on an offset value in addition to the legacy PDSCH processing timeline, where the offset value may be a predefined value or subject to a UE capability. In some aspects, the UE may receive, from the network node, an indication that the PDSCH processing timeline is to be the extended PDSCH processing timeline. The indication may be a one-bit flag indicated via a unicast RRC signaling, via DCI by repurposing a PRI field in a DCI format, or via an optional field in a DCI format associated with a G-RNTI/G-CS-RNTI configured with the NACK-only-based multicast feedback.

As shown by reference number 508, the UE may transmit, to the network node, the NACK-only-based multicast feedback using the quantity of PUCCH resources and based at least in part on the PDSCH processing timeline. For example, the UE may transmit the NACK-only-based multicast feedback using one allocated PUCCH resource or two allocated PUCCH resources. The PDSCH processing timeline may be the legacy PDSCH processing timeline or the extended PDSCH processing timeline, which may be based at least in part on the predefined value and subject to the UE capability.

In some aspects, a processing timeline for PUCCHs may be defined. The processing timeline for PUCCHs may depend on whether or not the UE is configured with the moreThanOneNackOnly-Mode.

In some aspects, when the moreThanOneNackOnly-Mode is not configured for the UE, NACK-only-based multicast feedback may be transformed to ACK/NACK-based feedback. The legacy PDSCH processing timeline may be applied for ACK/NACK based feedback.

In some aspects, when the moreThanOneNackOnly-Mode is configured for the UE, the network node may indicate, to the UE, an actual quantity of X TBs (e.g., X is less than or equal to four) to be multiplexed in the same PUCCH slot. Based at least in part on the indicated quantity of X TBs, the UE may determine whether to require (or use) more than one PUCCH for the NACK-only-based multicast feedback. As an example, for X≤3, the UE may select one of the PUCCH sequences with different cyclic shifts and/or OCCs in one allocated PUCCH time/frequency resource. As another example, for X=4, the UE may select PUCCH sequences in two allocated PUCCH time/frequency resources. In some aspects, the network node may indicate a value of X via RRC signaling or in DCI by repurposing a PRI field in a DCI format 4_1/4_2 associated with the G-RNTI/G-CS-RNTI configured with NACK-only-based multicast feedback.

In some aspects, based at least in part on required PUCCH(s) (e.g., a required quantity of PUCCH time/frequency resources based at least in part on the X TBs), the UE may determine whether to extend a PDSCH processing timeline. When one PUCCH is required to convey the NACK-only-based multicast feedback, the UE may use the legacy PDSCH processing timeline defined for ACK/NACK based feedback. Otherwise, the UE may use the extended PDSCH processing timeline, if configured. The extended PDSCH processing timeline may be defined in accordance with: T_{Proc1_NACK}=T_{Proc,1}+T_{offset}, where T_{offset} may be the predefined value and/or subject to the UE capability. For example, T_{offset} may be predefined as N1 plus the time gap between the end of the PDSCH and the end of the PDCCH. Alternatively, T_{offset} may be based at least in part on the required time reported by the UE. When the extended PDSCH processing timeline is configured, the UE may not be expected that the time gap between the end of PDSCH and the starting of PUCCH for NACK-only-based feedback is smaller than the required T_{Proc1_NACK}; otherwise, the UE may not be expected that the time gap between the end of PDSCH and the starting of PUCCH for NACK-only-based feedback is smaller than the required T_{Proc1}, similar as the timeline for ACK/NACK-based feedback.

In some aspects, the network node may explicitly indicate, to the UE, whether the UE is to apply the extended PDSCH processing timeline. For example, the network node may indicate the one-bit flag via unicast RRC signaling, in DCI by repurposing a PRI in DCI format 4_1/4_2, or by defining a new optional field in DCI format 4_2 associated with a G-RNT/G-CS-RNTI configured with NACK-only-based multicast feedback.

In some aspects, PUCCH resources for the NACK-only-based multicast feedback may be associated with frequency domain resources and time domain resources. The quantity of TB blocks with the NACK-only-based multicast feedback to be multiplexed in the PUCCH slot may be associated with more than one PUCCH resource.

In some aspects, a resource allocation for frequency domain PUCCH resources for the NACK-only-based multicast feedback using a PUCCH format 0 or a PUCCH format 1 and no interlaced mapping may be associated with the same or adjacent resource blocks, non-adjacent resource blocks and a same PUCCH transmission power, or non-adjacent resource blocks with different PUCCH transmission powers. In some aspects, a frequency hopping associated with PUCCH resources for the NACK-only-based multicast feedback may be based at least in part on one or more frequency hopping parameters per PUCCH resource. The one or more frequency hopping parameters may include an intra-slot frequency hopping parameter, a second hop physical resource block parameter, and/or an inter-slot frequency hopping parameter.

In some aspects, a resource allocation for time domain PUCCH resources for the NACK-only-based multicast feedback may be based at least in part on starting symbols for different PUCCH resources. The different PUCCH resources may be associated with a same starting symbol in the PUCCH slot, or the different PUCCH resources may be associated with different starting symbols in the PUCCH slot with a common starting symbol, an earlier starting symbol, or a first symbol of the PUCCH slot counted as the reference point. In some aspects, PUCCH resources for the NACK-only-based multicast feedback may be associated with one or more symbol quantities and one or more PUCCH formats. The PUCCH resources may be associated with a same quantity of symbols and a same PUCCH format, the quantity of PUCCH resources may be associated with a same quantity of symbols and different PUCCH formats, or the quantity of PUCCH resources may be associated with different quantities of symbols and different PUCCH formats.

In some aspects, the frequency domain resources may be allocated for the PUCCHs used for the NACK-only-based multicast feedback. When more than one PUCCH is needed to multiplex X TBs, the UE may be allocated with PUCCHs for NACK-only-based multicast feedback. PRBs for PUCCHs may be associated with PUCCH format 0 or PUCCH format 1 and no interlaced mapping. For example, the UE may be allocated with the same or adjacent resource blocks. The UE may be allocated with non-adjacent resource blocks but with the same PUCCH Tx power (e.g., using the same maximum power reduction (MPR)). The UE may be allocated with non-adjacent resource blocks but with different PUCCH Tx powers (e.g., using different MPRs). The UE may need additional time for adjusting a PUCCH Tx power at an RF side, where the additional time may need to be counted in the extended PDSCH processing timeline.

In some aspects, frequency hopping may be supported for PUCCHs of NACK-only-based multicast feedback. Frequency hopping parameters may be per PUCCH resource, if enabled, and may be configured to keep the same relative frequency locations of PUCCHs. The frequency hopping parameters may be associated with an intra-slot frequency hopping, a second hop PRB, and/or an inter-slot frequency hopping (when configured for PUCCH repetitions in multiple slots).

In some aspects, the time domain resources may be allocated for the PUCCHs used for the NACK-only-based multicast feedback. When more than one PUCCH is needed to multiplex X TBs, the UE may be allocated with PUCCHs for NACK-only-based multicast feedback. The starting symbol for the PUCCHs may be the same starting symbol in the same slot, or the starting symbol for the PUCCHs may be associated with different starting symbols in the same slot. An earliest symbol among the PUCCHs may be counted as a reference point for the PDSCH processing timeline. Alternatively, the first symbol of the PUCCH slot may be counted as a reference point for the PDSCH processing timeline.

In some aspects, a symbol number and format may be defined for the PUCCHs. In a first option, the same quantity of symbols and the same PUCCH format may be used, which may result in a similar PUCCH detection performance. For example, a 10-symbol PUCCH format 1 may be used for a first PUCCH and a 10-symbol PUCCH format 1 may be used for a second PUCCH. In a second option, the same quantity of symbols may be used, but different PUCCH formats may be permitted. For example, a two-symbol PUCCH format 1 may be used for a first PUCCH, and a two-symbol PUCCH format 0 may be used for a second PUCCH. In a third option, different quantities of symbols and different PUCCH formats may be used. For example, a 14-symbol PUCCH format 1 may be used for a first PUCCH and a two-symbol PUCCH format 0 may be used for a second PUCCH.

As indicated above, FIG. 5 is provided as an example. Other examples may differ from what is described with regard to FIG. 5.

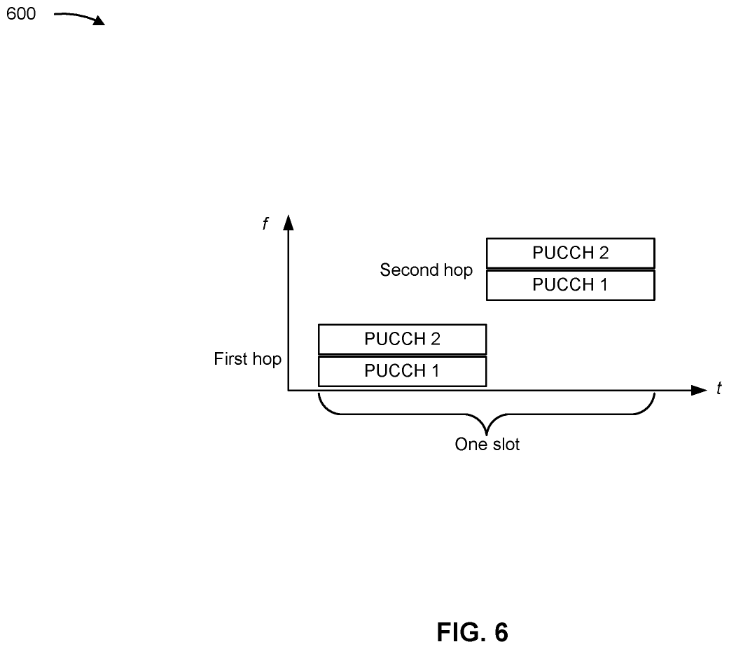

FIG. 6 is a diagram illustrating an example 600 associated with allocating uplink channel resources for NACK-only-based multicast feedback, in accordance with the present disclosure.

As shown in FIG. 6, frequency hopping may be supported for PUCCHs of NACK-only-based multicast feedback. Within one slot, a first hop may be associated with a first PUCCH and a second PUCCH, and a second hop may be associated with the first PUCCH and the second PUCCH. The frequency hopping involving the first hop and the second hop, and the first PUCCH and the second PUCCH, may be based at least in part on an intra-slot frequency hopping parameter, a second hop PRB parameter, and/or an inter-slot frequency hopping parameter.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with allocating uplink channel resources for NACK-only-based multicast feedback.

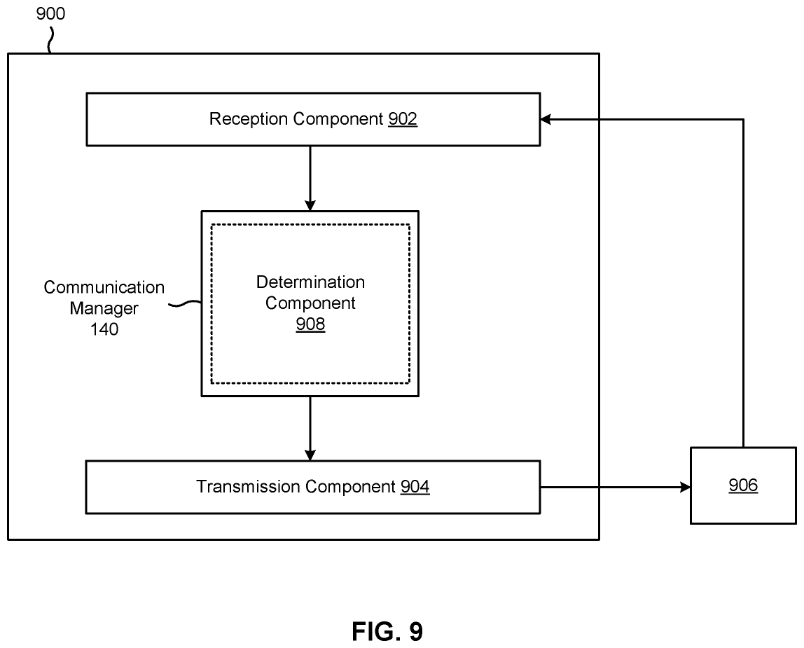

As shown in FIG. 7, in some aspects, process 700 may include receiving, from a network node, an indication of one of: a quantity of PUCCH resources in a PUCCH slot for NACK-only-based multicast feedback, or a quantity of TBs with the NACK-only-based multicast feedback to be multiplexed in the PUCCH slot (block 710). For example, the UE (e.g., using communication manager 140 and/or reception component 902, depicted in FIG. 9) may receive, from a network node, an indication of one of: a quantity of PUCCH resources in a PUCCH slot for NACK-only-based multicast feedback, or a quantity of TBs with the NACK-only-based multicast feedback to be multiplexed in the PUCCH slot, as described above.

As further shown in FIG. 7, in some aspects, process 700 may include determining, based at least in part on the indication, the quantity of PUCCH resources in the PUCCH slot for the NACK-only-based multicast feedback (block 720). For example, the UE (e.g., using communication manager 140 and/or determination component 908, depicted in FIG. 9) may determine, based at least in part on the indication, the quantity of PUCCH resources in the PUCCH slot for the NACK-only-based multicast feedback, as described above.

As further shown in FIG. 7, in some aspects, process 700 may include determining a PDSCH processing timeline based at least in part on the quantity of PUCCH resources for the NACK-only-based multicast feedback (block 730). For example, the UE (e.g., using communication manager 140 and/or determination component 908, depicted in FIG. 9) may determine a PDSCH processing timeline based at least in part on the quantity of PUCCH resources for the NACK-only-based multicast feedback, as described above.

As further shown in FIG. 7, in some aspects, process 700 may include transmitting, to the network node, the NACK-only-based multicast feedback using the quantity of PUCCH resources and based at least in part on the PDSCH processing timeline (block 740). For example, the UE (e.g., using communication manager 140 and/or transmission component 904, depicted in FIG. 9) may transmit, to the network node, the NACK-only-based multicast feedback using the quantity of PUCCH resources and based at least in part on the PDSCH processing timeline, as described above.

Process 700 may include additional aspects, such as any single aspect or any combination of aspects described below and/or in connection with one or more other processes described elsewhere herein.

In a first aspect, a more-than-one-NACK-only-mode is configured for the UE.

In a second aspect, alone or in combination with the first aspect, the quantity of PUCCH resources is one based at least in part on the quantity of TBs being less than or equal to a predefined value.

In a third aspect, alone or in combination with one or more of the first and second aspects, the quantity of PUCCH resources is more than one based at least in part on the quantity of TBs being larger than a predefined value.

In a fourth aspect, alone or in combination with one or more of the first through third aspects, the indication is received via a unicast RRC signaling.

In a fifth aspect, alone or in combination with one or more of the first through fourth aspects, the indication is received via DCI based at least in part on repurposing a PRI field in a DCI format that is associated with a G-RNTI/G-CS-RNTI configured with the NACK-only-based multicast feedback.

In a sixth aspect, alone or in combination with one or more of the first through fifth aspects, the PDSCH processing timeline is a legacy PDSCH processing timeline used for ACK/NACK based feedback based at least in part on the quantity of PUCCH resources being one.

In a seventh aspect, alone or in combination with one or more of the first through sixth aspects, the PDSCH processing timeline is an extended PDSCH processing timeline based at least in part on the quantity of PUCCH resources being greater than one, wherein the extended PDSCH processing timeline is based at least in part on an offset value in addition to a legacy PDSCH processing timeline, and the offset value is a predefined value or subject to a UE capability.

In an eighth aspect, alone or in combination with one or more of the first through seventh aspects, process 700 includes receiving, from the network node, an indication that the PDSCH processing timeline is to be an extended PDSCH processing timeline, wherein the indication is a one-bit flag indicated via a unicast RRC signaling, via DCI by repurposing a PRI field in a DCI format, or via an optional field in a DCI format associated with a G-RNTI/G-CS-RNTI configured with the NACK-only-based multicast feedback.

In a ninth aspect, alone or in combination with one or more of the first through eighth aspects, PUCCH resources for the NACK-only-based multicast feedback are associated with frequency domain resources and time domain resources, and the quantity of TBs with the NACK-only-based multicast feedback to be multiplexed in the PUCCH slot is associated with more than one PUCCH resource.

In a tenth aspect, alone or in combination with one or more of the first through ninth aspects, a resource allocation for frequency domain PUCCH resources for the NACK-only-based multicast feedback using a PUCCH format 0 or a PUCCH format 1 and no interlaced mapping is associated with one of: same or adjacent resource blocks, non-adjacent resource blocks and a same PUCCH transmission power, or non-adjacent resource blocks with different PUCCH transmission powers.

In an eleventh aspect, alone or in combination with one or more of the first through tenth aspects, a frequency hopping associated with PUCCH resources for the NACK-only-based multicast feedback is based at least in part on one or more frequency hopping parameters per PUCCH resource, and the one or more frequency hopping parameters include one or more of an intra-slot frequency hopping parameter, a second hop physical resource block parameter, or an inter-slot frequency hopping parameter.

In a twelfth aspect, alone or in combination with one or more of the first through eleventh aspects, a resource allocation for time domain PUCCH resources for the NACK-only-based multicast feedback is based at least in part on starting symbols for different PUCCH resources, and the different PUCCH resources are associated with a same starting symbol in the PUCCH slot, or the different PUCCH resources are associated with different starting symbols in the PUCCH slot with a common starting symbol, an earlier starting symbol or a first symbol of the PUCCH slot counted as a reference point.

In a thirteenth aspect, alone or in combination with one or more of the first through twelfth aspects, PUCCH resources for the NACK-only-based multicast feedback are associated with one or more symbol quantities and one or more PUCCH formats, and the PUCCH resources are associated with a same quantity of symbols and a same PUCCH format, the quantity of PUCCH resources are associated with a same quantity of symbols and different PUCCH formats, or the quantity of PUCCH resources are associated with different quantities of symbols and different PUCCH formats.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with allocating uplink channel resources for NACK-only-based multicast feedback.

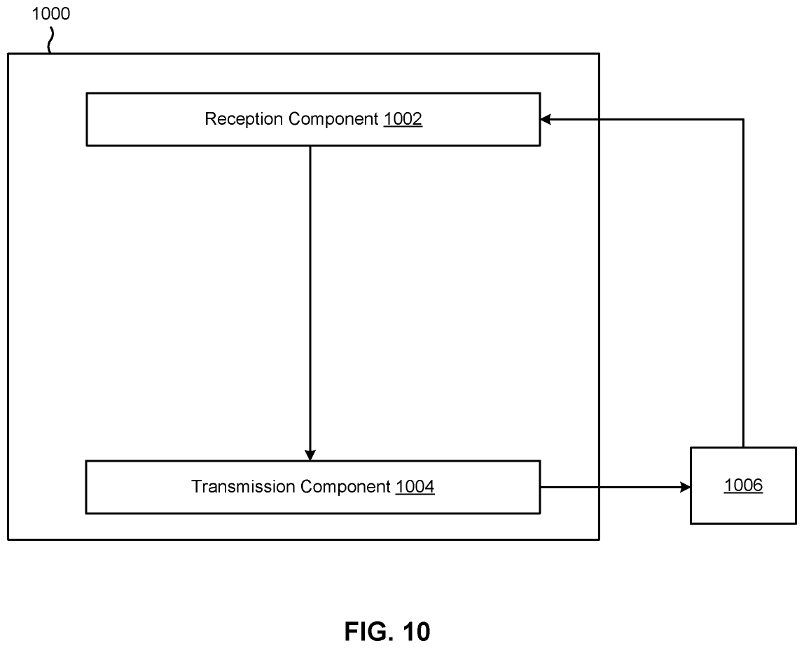

As shown in FIG. 8, in some aspects, process 800 may include transmitting, to a UE, an indication of one of: a quantity of PUCCH resources in a PUCCH slot for NACK-only-based multicast feedback, or a quantity of TBs with the NACK-only-based multicast feedback to be multiplexed in the PUCCH slot (block 810). For example, the network node (e.g., using transmission component 1004, depicted in FIG. 10) may transmit, to a UE, an indication of one of: a quantity of PUCCH resources in a PUCCH slot for NACK-only-based multicast feedback, or a quantity of TBs with the NACK-only-based multicast feedback to be multiplexed in the PUCCH slot, as described above.

As further shown in FIG. 8, in some aspects, process 800 may include receiving, from the UE, the NACK-only-based multicast feedback based at least in part on the quantity of PUCCH resources and a PDSCH processing timeline, wherein the quantity of PUCCH resources is based at least in part on the indication, and wherein the PDSCH processing timeline is based at least in part on the quantity of PUCCH resources for the NACK-only-based multicast feedback (block 820). For example, the network node (e.g., using reception component 1002, depicted in FIG. 10) may receive, from the UE, the NACK-only-based multicast feedback based at least in part on the quantity of PUCCH resources and a PDSCH processing timeline, wherein the quantity of PUCCH resources is based at least in part on the indication, and wherein the PDSCH processing timeline is based at least in part on the quantity of PUCCH resources for the NACK-only-based multicast feedback, as described above.

Process 800 may include additional aspects, such as any single aspect or any combination of aspects described below and/or in connection with one or more other processes described elsewhere herein.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include a determination component 908, among other examples.

In some aspects, the apparatus 900 may be configured to perform one or more operations described herein in connection with FIGS. 5-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive, from a network node, an indication of one of: a quantity of PUCCH resources in a PUCCH slot for NACK-only-based multicast feedback, or a quantity of TBs with the NACK-only-based multicast feedback to be multiplexed in the PUCCH slot. The determination component 908 may determine, based at least in part on the indication, the quantity of PUCCH resources in the PUCCH slot for the NACK-only-based multicast feedback. The determination component 908 may determine a PDSCH processing timeline based at least in part on the quantity of PUCCH resources for the NACK-only-based multicast feedback. The transmission component 904 may transmit, to the network node, the NACK-only-based multicast feedback using the quantity of PUCCH resources and based at least in part on the PDSCH processing timeline.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004.

In some aspects, the apparatus 1000 may be configured to perform one or more operations described herein in connection with FIGS. 5-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The transmission component 1004 may transmit, to a UE, an indication of one of: a quantity of PUCCH resources in a PUCCH slot for NACK-only-based multicast feedback, or a quantity of TBs with the NACK-only-based multicast feedback to be multiplexed in the PUCCH slot. The reception component 1002 may receive, from the UE, the NACK-only-based multicast feedback based at least in part on the quantity of PUCCH resources and a PDSCH processing timeline, wherein the quantity of PUCCH resources is based at least in part on the indication, and wherein the PDSCH processing timeline is based at least in part on the quantity of PUCCH resources for the NACK-only-based multicast feedback.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving, from a network node, an indication of one of: a quantity of physical uplink control channel (PUCCH) resources in a PUCCH slot for negative acknowledgement (NACK)-only-based multicast feedback, or a quantity of transport blocks (TBs) with the NACK-only-based multicast feedback to be multiplexed in the PUCCH slot; determining, based at least in part on the indication, the quantity of PUCCH resources in the PUCCH slot for the NACK-only-based multicast feedback; determining a physical downlink shared channel (PDSCH) processing timeline based at least in part on the quantity of PUCCH resources for the NACK-only-based multicast feedback; and transmitting, to the network node, the NACK-only-based multicast feedback using the quantity of PUCCH resources and based at least in part on the PDSCH processing timeline.

Aspect 2: The method of Aspect 1, wherein a more-than-one-NACK-only-mode is configured for the UE.

Aspect 3: The method of any of Aspects 1 through 2, wherein the quantity of PUCCH resources is one based at least in part on the quantity of TBs being less than or equal to a predefined value.

Aspect 4: The method of any of Aspects 1 through 3, wherein the quantity of PUCCH resources is more than one based at least in part on the quantity of TBs being larger than a predefined value.

Aspect 5: The method of any of Aspects 1 through 4, wherein the indication is received via a unicast radio resource control signaling.

Aspect 6: The method of any of Aspects 1 through 5, wherein the indication is received via downlink control information (DCI) based at least in part on repurposing a PUCCH resource identifier field in a DCI format that is associated with a group radio network temporary identifier (RNTI) or group configured scheduling RNTI configured with the NACK-only-based multicast feedback.

Aspect 7: The method of any of Aspects 1 through 6, wherein the PDSCH processing timeline is a PDSCH processing timeline used for acknowledgement (ACK) or NACK based feedback based at least in part on the quantity of PUCCH resources being one.

Aspect 8: The method of any of Aspects 1 through 7, wherein the PDSCH processing timeline is an extended PDSCH processing timeline based at least in part on the quantity of PUCCH resources being greater than one, wherein the extended PDSCH processing timeline is based at least in part on an offset value in addition to a legacy PDSCH processing timeline, and wherein the offset value is a predefined value or subject to a UE capability.

Aspect 9: The method of any of Aspects 1 through 8, further comprising: receiving, from the network node, an indication that the PDSCH processing timeline is to be an extended PDSCH processing timeline, wherein the indication is a one-bit flag indicated via a unicast radio resource control signaling, via downlink control information (DCI) by repurposing a PUCCH resource identifier field in a DCI format, or via an optional field in a DCI format associated with a group radio network temporary identifier (RNTI) or group configured scheduling RNTI configured with the NACK-only-based multicast feedback.

Aspect 10: The method of any of Aspects 1 through 9, wherein PUCCH resources for the NACK-only-based multicast feedback are associated with frequency domain resources and time domain resources, and wherein the quantity of TBs with the NACK-only-based multicast feedback to be multiplexed in the PUCCH slot is associated with more than one PUCCH resource.

Aspect 11: The method of any of Aspects 1 through 10, wherein a resource allocation for frequency domain PUCCH resources for the NACK-only-based multicast feedback using a PUCCH format 0 or a PUCCH format 1 and no interlaced mapping is associated with one of: same or adjacent resource blocks and a same PUCCH transmission power, non-adjacent resource blocks and the same PUCCH transmission power, or non-adjacent resource blocks with different PUCCH transmission powers, wherein the same PUCCH transmission power is associated with a same maximum power reduction (MPR), and the different PUCCH transmission powers are associated with different MPRs.

Aspect 12: The method of any of Aspects 1 through 11, wherein a frequency hopping associated with PUCCH resources for the NACK-only-based multicast feedback is based at least in part on one or more frequency hopping parameters per PUCCH resource, and wherein the one or more frequency hopping parameters include one or more of an intra-slot frequency hopping parameter, a second hop physical resource block parameter, or an inter-slot frequency hopping parameter.

Aspect 13: The method of any of Aspects 1 through 12, wherein a resource allocation for time domain PUCCH resources for the NACK-only-based multicast feedback is based at least in part on starting symbols for different PUCCH resources, and wherein the different PUCCH resources are associated with a same starting symbol in the PUCCH slot, or the different PUCCH resources are associated with different starting symbols in the PUCCH slot with a common starting symbol, an earlier starting symbol or a first symbol of the PUCCH slot counted as a reference point.

Aspect 14: The method of any of Aspects 1 through 13, wherein PUCCH resources for the NACK-only-based multicast feedback are associated with one or more symbol quantities and one or more PUCCH formats, and wherein the PUCCH resources are associated with a same quantity of symbols and a same PUCCH format, the quantity of PUCCH resources are associated with a same quantity of symbols and different PUCCH formats, or the quantity of PUCCH resources are associated with different quantities of symbols and different PUCCH formats.

Aspect 15: A method of wireless communication performed by a network node, comprising: transmitting, to a user equipment (UE), an indication of one of: a quantity of physical uplink control channel (PUCCH) resources in a PUCCH slot for negative acknowledgement (NACK)-only-based multicast feedback, or a quantity of transport blocks (TBs) with the NACK-only-based multicast feedback to be multiplexed in the PUCCH slot; and receiving, from the UE, the NACK-only-based multicast feedback based at least in part on the quantity of PUCCH resources and a physical downlink shared channel (PDSCH) processing timeline, wherein the quantity of PUCCH resources is based at least in part on the indication, and wherein the PDSCH processing timeline is based at least in part on the quantity of PUCCH resources for the NACK-only-based multicast feedback.

Aspect 16: An apparatus for wireless communication at a device, comprising a processor; memory coupled with the processor; and instructions stored in the memory and executable by the processor to cause the apparatus to perform the method of one or more of Aspects 1-14.

Aspect 17: A device for wireless communication, comprising a memory and one or more processors coupled to the memory, the one or more processors configured to perform the method of one or more of Aspects 1-14.

Aspect 18: An apparatus for wireless communication, comprising at least one means for performing the method of one or more of Aspects 1-14.

Aspect 19: A non-transitory computer-readable medium storing code for wireless communication, the code comprising instructions executable by a processor to perform the method of one or more of Aspects 1-14.

Aspect 20: A non-transitory computer-readable medium storing a set of instructions for wireless communication, the set of instructions comprising one or more instructions that, when executed by one or more processors of a device, cause the device to perform the method of one or more of Aspects 1-14.

Aspect 21: An apparatus for wireless communication at a device, comprising a processor; memory coupled with the processor; and instructions stored in the memory and executable by the processor to cause the apparatus to perform the method of Aspect 15.

Aspect 22: A device for wireless communication, comprising a memory and one or more processors coupled to the memory, the one or more processors configured to perform the method of Aspect 15.

Aspect 23: An apparatus for wireless communication, comprising at least one means for performing the method of Aspect 15.

Aspect 24: A non-transitory computer-readable medium storing code for wireless communication, the code comprising instructions executable by a processor to perform the method of Aspect 15.

Aspect 25: A non-transitory computer-readable medium storing a set of instructions for wireless communication, the set of instructions comprising one or more instructions that, when executed by one or more processors of a device, cause the device to perform the method of Aspect 15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors coupled to the one or more memories, the one or more processors individually or collectively configured to:
receive, from a network node, an indication of one of: a quantity of physical uplink control channel (PUCCH) resources in a PUCCH slot for negative acknowledgement (NACK)-only-based multicast feedback, or a quantity of transport blocks (TBs) with the NACK-only-based multicast feedback to be multiplexed in the PUCCH slot;
determine, based at least in part on the indication, the quantity of PUCCH resources in the PUCCH slot for the NACK-only-based multicast feedback;
determine a physical downlink shared channel (PDSCH) processing timeline based at least in part on the quantity of PUCCH resources for the NACK-only-based multicast feedback; and
transmit, to the network node, the NACK-only-based multicast feedback using the quantity of PUCCH resources and based at least in part on the PDSCH processing timeline.

2. The apparatus of claim 1, wherein a more-than-one-NACK-only-mode is configured for the UE.

3. The apparatus of claim 1, wherein the quantity of PUCCH resources is one based at least in part on the quantity of TBs being less than or equal to a predefined value.

4. The apparatus of claim 1, wherein the quantity of PUCCH resources is more than one based at least in part on the quantity of TBs being larger than a predefined value.

5. The apparatus of claim 1, wherein the one or more processors are individually or collectively configured to receive the indication via a unicast radio resource control signaling.

6. The apparatus of claim 1, wherein the one or more processors are individually or collectively configured to receive the indication via downlink control information (DCI) based at least in part on repurposing a PUCCH resource identifier field in a DCI format that is associated with a group radio network temporary identifier (RNTI) or group configured scheduling RNTI configured with the NACK-only-based multicast feedback.

7. The apparatus of claim 1, wherein the PDSCH processing timeline is a PDSCH processing timeline used for acknowledgement (ACK) or NACK based feedback based at least in part on the quantity of PUCCH resources being one.

8. The apparatus of claim 1, wherein the one or more processors are further individually or collectively configured to:
receive, from the network node, an indication that the PDSCH processing timeline is to be an extended PDSCH processing timeline, wherein the indication is a one-bit flag indicated via a unicast radio resource control signaling, via downlink control information (DCI) by repurposing a PUCCH resource identifier field in a DCI format, or via an optional field in a DCI format associated with a group radio network temporary identifier (RNTI) or group configured scheduling RNTI configured with the NACK-only-based multicast feedback.

9. The apparatus of claim 1, wherein PUCCH resources for the NACK-only-based multicast feedback are associated with frequency domain resources and time domain resources, and wherein the quantity of TBs with the NACK-only-based multicast feedback to be multiplexed in the PUCCH slot is associated with more than one PUCCH resource.

10. The apparatus of claim 1, wherein a resource allocation for frequency domain PUCCH resources for the NACK-only-based multicast feedback using a PUCCH format 0 or a PUCCH format 1 and no interlaced mapping is associated with one of: same or adjacent resource blocks and a same PUCCH transmission power, non-adjacent resource blocks and the same PUCCH transmission power, or non-adjacent resource blocks with different PUCCH transmission powers.

11. The apparatus of claim 10, wherein the same PUCCH transmission power is associated with a same maximum power reduction (MPR), and the different PUCCH transmission powers are associated with different MPRs.

12. The apparatus of claim 1, wherein a frequency hopping associated with PUCCH resources for the NACK-only-based multicast feedback is based at least in part on one or more frequency hopping parameters per PUCCH resource, and wherein the one or more frequency hopping parameters include one or more of an intra-slot frequency hopping parameter, a second hop physical resource block parameter, or an inter-slot frequency hopping parameter.

13. The apparatus of claim 1, wherein a resource allocation for time domain PUCCH resources for the NACK-only-based multicast feedback is based at least in part on starting symbols for different PUCCH resources, and wherein the different PUCCH resources are associated with a same starting symbol in the PUCCH slot, or the different PUCCH resources are associated with different starting symbols in the PUCCH slot with a common starting symbol, an earlier starting symbol or a first symbol of the PUCCH slot counted as a reference point.

14. The apparatus of claim 1, wherein PUCCH resources for the NACK-only-based multicast feedback are associated with one or more symbol quantities and one or more PUCCH formats, and wherein the PUCCH resources are associated with a same quantity of symbols and a same PUCCH format, the quantity of PUCCH resources are associated with a same quantity of symbols and different PUCCH formats, or the quantity of PUCCH resources are associated with different quantities of symbols and different PUCCH formats.

15. An apparatus for wireless communication at a network node, comprising:
one or more memories; and
one or more processors coupled to the one or more memories, the one or more processors individually or collectively configured to:
transmit, to a user equipment (UE), an indication of one of: a quantity of physical uplink control channel (PUCCH) resources in a PUCCH slot for negative acknowledgement (NACK)-only-based multicast feedback, or a quantity of transport blocks (TBs) with the NACK-only-based multicast feedback to be multiplexed in the PUCCH slot; and
receive, from the UE, the NACK-only-based multicast feedback based at least in part on the quantity of PUCCH resources and a physical downlink shared channel (PDSCH) processing timeline, wherein the quantity of PUCCH resources is based at least in part on the indication, and wherein the PDSCH processing timeline is based at least in part on the quantity of PUCCH resources for the NACK-only-based multicast feedback.

16. A method of wireless communication performed by a user equipment (UE), comprising:
receiving, from a network node, an indication of one of: a quantity of physical uplink control channel (PUCCH) resources in a PUCCH slot for negative acknowledgement (NACK)-only-based multicast feedback, or a quantity of transport blocks (TBs) with the NACK-only-based multicast feedback to be multiplexed in the PUCCH slot;
determining, based at least in part on the indication, the quantity of PUCCH resources in the PUCCH slot for the NACK-only-based multicast feedback;
determining a physical downlink shared channel (PDSCH) processing timeline based at least in part on the quantity of PUCCH resources for the NACK-only-based multicast feedback; and
transmitting, to the network node, the NACK-only-based multicast feedback using the quantity of PUCCH resources and based at least in part on the PDSCH processing timeline.

17. The method of claim 16, wherein a more-than-one-NACK-only-mode is configured for the UE.

18. The method of claim 16, wherein the quantity of PUCCH resources is one based at least in part on the quantity of TBs being less than or equal to a predefined value.

19. The method of claim 16, wherein the quantity of PUCCH resources is more than one based at least in part on the quantity of TBs being larger than a predefined value.

20. The method of claim 16, wherein the indication is received via a unicast radio resource control signaling.

21. The method of claim 16, wherein the indication is received via downlink control information (DCI) based at least in part on repurposing a PUCCH resource identifier field in a DCI format that is associated with a group radio network temporary identifier (RNTI) or group configured scheduling RNTI configured with the NACK-only-based multicast feedback.

22. The method of claim 16, wherein the PDSCH processing timeline is a PDSCH processing timeline used for acknowledgement (ACK) or NACK based feedback based at least in part on the quantity of PUCCH resources being one.

23. The method of claim 16, further comprising:
receiving, from the network node, an indication that the PDSCH processing timeline is to be an extended PDSCH processing timeline, wherein the indication is a one-bit flag indicated via a unicast radio resource control signaling, via downlink control information (DCI) by repurposing a PUCCH resource identifier field in a DCI format, or via an optional field in a DCI format associated with a group radio network temporary identifier (RNTI) or group configured scheduling RNTI configured with the NACK-only-based multicast feedback.

24. The method of claim 16, wherein PUCCH resources for the NACK-only-based multicast feedback are associated with frequency domain resources and time domain resources, and wherein the quantity of TBs with the NACK-only-based multicast feedback to be multiplexed in the PUCCH slot is associated with more than one PUCCH resource.

25. The method of claim 16, wherein a resource allocation for frequency domain PUCCH resources for the NACK-only-based multicast feedback using a PUCCH format 0 or a PUCCH format 1 and no interlaced mapping is associated with one of: same or adjacent resource blocks and a same PUCCH transmission power, non-adjacent resource blocks and the same PUCCH transmission power, or non-adjacent resource blocks with different PUCCH transmission powers.

26. The method of claim 25, wherein the same PUCCH transmission power is associated with a same maximum power reduction (MPR), and the different PUCCH transmission powers are associated with different MPRs.

27. The method of claim 16, wherein a frequency hopping associated with PUCCH resources for the NACK-only-based multicast feedback is based at least in part on one or more frequency hopping parameters per PUCCH resource, and wherein the one or more frequency hopping parameters include one or more of an intra-slot frequency hopping parameter, a second hop physical resource block parameter, or an inter-slot frequency hopping parameter.

28. The method of claim 16, wherein a resource allocation for time domain PUCCH resources for the NACK-only-based multicast feedback is based at least in part on starting symbols for different PUCCH resources, and wherein the different PUCCH resources are associated with a same starting symbol in the PUCCH slot, or the different PUCCH resources are associated with different starting symbols in the PUCCH slot with a common starting symbol, an earlier starting symbol or a first symbol of the PUCCH slot counted as a reference point.

29. The method of claim 16, wherein PUCCH resources for the NACK-only-based multicast feedback are associated with one or more symbol quantities and one or more PUCCH formats, and wherein the PUCCH resources are associated with a same quantity of symbols and a same PUCCH format, the quantity of PUCCH resources are associated with a same quantity of symbols and different PUCCH formats, or the quantity of PUCCH resources are associated with different quantities of symbols and different PUCCH formats.

30. A method of wireless communication performed by a network node, comprising:
transmitting, to a user equipment (UE), an indication of one of: a quantity of physical uplink control channel (PUCCH) resources in a PUCCH slot for negative acknowledgement (NACK)-only-based multicast feedback, or a quantity of transport blocks (TBs) with the NACK-only-based multicast feedback to be multiplexed in the PUCCH slot; and
receiving, from the UE, the NACK-only-based multicast feedback based at least in part on the quantity of PUCCH resources and a physical downlink shared channel (PDSCH) processing timeline, wherein the quantity of PUCCH resources is based at least in part on the indication, and wherein the PDSCH processing timeline is based at least in part on the quantity of PUCCH resources for the NACK-only-based multicast feedback.
